(19) United States
(12) Patent Application Publication
(10) Pub. No.: US 2006/0278629 A1
(43) Pub. Date: Dec. 14, 2006

(54) Electronically controlled outdoor warmer

(75) Inventors: John M. Gagas, Milwaukee, WI (US); Richard C. Hochschild JR., Grafton, WI (US); Scott A. Jonovic, Cottage Grove, WI (US); Daniel E. Stair II, Cedarburg, WI (US)

Correspondence Address: BOYLE FREDRICKSON NEWHOLM STEIN & GRATZ, S.C., 250 E. WISCONSIN AVENUE, SUITE 1030, MILWAUKEE, WI, 53202, US

(73) Assignee: Western Industries, Inc.

(21) Appl. No.: 11/500,074

(22) Filed: Aug. 7, 2006

Related U.S. Application Data
(63) Continuation-in-part of application No. 11/147,511, filed on Jun. 8, 2005.
(63) Continuation-in-part of application No. 11/216,443, filed on Aug. 31, 2005.
(63) Continuation-in-part of application No. 11/216,314, filed on Aug. 31, 2005.

(51) Int. Cl. G05D 23/12; F27D 11/00; A21B 1/22; H05B 1/02

(52) U.S. Cl. 219/385; 236/1 C; 219/494; 219/391

(57) ABSTRACT

An electronically controlled warmer with a user interface, a venting/cooling system, a fan, and an element uses one or more seals to protect objects in the chamber from the elements and facilitate use outdoors. The system is controlled by way of a user interface that interacts with the electronic control system to operate the heating elements. A sensor or sensor system sends signals to the electronic control system that then regulates the venting system and fans. The drawer has programmable operations, functions, and numerous set points.

### CROSS REFERENCE TO RELATED APPLICATIONS

This application claims the benefit of priority of presently co-pending U.S. application Ser. No. 11/216,443, filed Aug. 31, 2005 and entitled “Warming Apparatus,” U.S. application Ser. No. 11/216,314, filed Aug. 31, 2005 and entitled “Non-food Warmer Appliance,” and U.S. application Ser. No. 11/147,511, filed Jun. 8, 2005 and entitled “Factory Preset Temperature Warming Appliance,” the entirety of which are incorporated herein by reference.

### FIELD OF THE INVENTION

The present invention relates to warmer appliances and, more particularly to an electronically controlled warmer apparatus sealed for use outdoors.

### BACKGROUND OF THE INVENTION

Warmers and warming drawers are generally closed boxes having a single or double-wall construction with insulation or air in between the walls. A sliding drawer is often provided to allow access to the interior of the box. In general, a front door covers the access hole and is fixed in a vertical plane. Heating of the box is generally accomplished by the use of a single calrod (sheathed heating element) to radiate heat throughout the inside of the chamber. Typically, the housing, door, and chamber are not sealed to protect the objects placed in the box from moisture, insects, chemicals and other environmental contaminants. Often, there are large openings or gaps in the construction of the present day units. Such construction permits fluids and various environmental contaminants to penetrate into the critical areas of the box and cause damage. Drawer sealing for mechanically controlled outdoor use has typically been accomplished by filling the openings of the drawer with silicon calk. Over time, silicon calk is known to break down and permit fluids and other contaminants to enter and damage the drawer. As mechanically controlled warmer drawers presently in use were designed for indoor use, users that have used the warmer drawers outdoors have experienced failures. For example, present designs typically include vent openings on the drawer to remove moisture from the chamber. However, such vent openings allow wind to enter the chamber when used outdoors and can result in under and overshoots in temperature.

Present mechanically controlled outdoor warmer drawers do not provide a barrier to prevent insects and animals from entering. The presence of food in the chamber as well as the warmth emitted from the warmer drawer, attracts insects and animals to warmer drawers that are stored outdoors. The congregation of small animals or insects in the device has been known to damage the device or even cause the device to catch fire.

Conventional outdoor warmer drawers suffer other disadvantages as well. For example, the sensors used to detect the temperature in the drawer are typically capillary tube devices or the like. As temperature increases or decreases in such devices, a mechanical switch opens or closes turning current on or off to the calrod or axial fan. The typical response time for these types of controls tend to be undesirably slow and often results in over and undershoots in temperature. These characteristic temperature swings typically result in longer warm up times. In addition, temperature undershoots often prevent the objects in the drawer from ever reaching the desired temperature. Thus, the likelihood that a user will receive a properly warmed item is greatly reduced.

Conventional outdoor warmer drawers also often provide fans on the top and sides of the warming chamber and provide a calrod (used in varying patterns) on the bottom of the box to provide radiant heat. The radiant heat tends to rise slowly, warming from the bottom to the top of the chamber. This radiant heat usually produces “hot spots” when reaching a pan or plate positioned above it. Such temperature hot spots are generally due to the radiant heat source being strongest (hottest) near the calrod and decreasing in temperature as distance away from the calrod increases.

Varying temperature levels within the chamber tend to make it difficult to control and maintain the temperature of the object in the chamber. In some instances, temperature stratification or “layering” prevents even and uniform heating of the objects. In addition, startup times to attain the desired temperature in the box can be long, due in part to the calrod design. For example, applying too much heat too quickly will cause the bottom of a heat sensitive object such as a folded towel or a food item to burn before the other parts of the towel or food item reach the desired temperature. The conventional warmer drawers usually attempt to compensate for such problems by providing longer startup times. However, these long startup times generally prevent a user from simply turning the warmer drawer on, inserting an item, and achieving an acceptably warm object in a reasonably short period of time.

Many conventional warmer drawers currently use knobs and slides to “set” and control mechanical switches for selecting the temperature for the drawer. Such mechanical switches tend to have undesirable inaccuracies in their setting and the repeatability of a particular setting. Mechanical control switches generally exhibit hysteresis, which contributes to inaccuracies in the ability of the control device to obtain a set point or repeat a function. For example, this can be seen in some conventional warmer drawers by turning the control switch to the right and stopping at a set point; then for comparison, turning the same mechanical switch past the desired set point and then turning the control to the left, stopping at the set point. Both actions end with the same set point indicated on the switch, but the resulting temperature in the box is often different. The inherent inaccuracy with the mechanical switching devices and controls tend to exacerbate the effects of temperature overshoots and undershoots and the resulting temperature variations experienced by the object. In order to compensate for (or mask) such inaccuracies, many conventional warmer drawers apply control selections that indicate low, medium, and high (or the like), rather than a specific temperature setting. In such applications, a user generally cannot see the set point differences from one use to the next. Temperature swings as much as 30 degrees or more have been seen in such instances and detract from the ability to provide accurate, rapid and uniform heating of objects.

Another disadvantage of many present day designs is that they are typically designed for “built-in” installations such as to cabinetry, to a wall, or into another appliance, which tends to limit the available uses for the warmer drawer. Conventional warmer drawers generally do not permit usage as a freestanding unit, mobile unit, under a cabinet unit (e.g. suspended or the like), or in other areas that do not have the ability to support a structural frame.

Therefore a need exists for an outdoor warmer drawer with more accurate and controlled heating of objects (e.g. foods, drinks, towels, etc). There also exists the need for an accurate method of controlling the operations and settings of the outdoor warmer drawer. There also exists a need for controls that are not susceptible to damage when used outdoors. Another need exists for a display device to more easily permit a user to be able to view/see the operation, temperature indication(s), set point functions, and view of the contents of the chamber. A need also exists for a warmer drawer that can be used in any location desired by the user.

The below-referenced U.S. patents disclose embodiments that were at least, in part, satisfactory for the purposes for which they were intended. The disclosures of all the below-referenced prior U.S. patents in their entireties are hereby expressly incorporated by reference into the present application for purposes including, but not limited to, indicating the background of the present invention and illustrating the state of the art.

U.S. Pat. No. 6,849,835 pertains to a household food warmer for keeping foods and beverages warm including a housing, a drawer which can be inserted into the housing, an interior chamber which is bounded by the housing and the inserted drawer and which is used to accommodate foods placed on plates, a heating element, an electrical circuit in which is arranged a first electrical switch for switching on the heating element, and a temperature sensor for measuring the interior chamber temperature. A convection fan is also provided in this particular design. The convection fan can be switched on via a second electrical switch arranged in the electrical circuit and can be switched off via the second electrical switch upon the occurrence of a switching condition that is dependent on the temperature sensor.

U.S. Pat. No. 6,191,391 pertains to a warmer drawer for a domestic range that is disposed within a heating chamber located relatively beneath the oven. The heating chamber is surrounded by a series of panels, and has a heating element disposed therein. The heating element is energized in accordance with a user-determined duty cycle such that temperature within the heating chamber is maintained between a predetermined minimum temperature and a predetermined maximum temperature. The range of temperatures between the predetermined minimum and predetermined maximum correspond to a range of desired food serving temperatures at the warmer drawer.

U.S. Pat. No. 6,166,353 discloses a freestanding warming appliance and includes an outer enclosure and an inner liner, which cooperate together to form a heating chamber. A heating element is secured to the inner liner within the heating chamber to warm the foodstuffs within the warmer drawer receptacle. A control panel has an indicator light and infinite switch for controlling the heating element. The control panel is located within the enclosure and covered by a front panel of the warmer drawer so that access to the control components of the control panel is provided only when the warmer drawer is withdrawn from the heating chamber. Oven support members are secured to the outer enclosure to support a cooking appliance, such as a built-in oven, above the freestanding warming appliance. The cooking appliance rests directly on the oven support members of the warming appliance.

As the above attempts are lacking in some respect, there exists a need for a state-of-the-art electronically controlled outdoor warmer drawer that is constructed and sealed for outdoor use.

Further, there is a need for controls that are less susceptible to failure after exposure to the environment. There is a further need for a more accurate, versatile, and even heat control, and construction so that the device may be installed into existing appliances or used independently in a plurality of locations.

### SUMMARY OF THE INVENTION

One object of this invention is to provide a warming apparatus that has one or more of the characteristics discussed below.

The present inventive warmer apparatus for either indoor or outdoor use consists of an enclosure defining a chamber with a heating element operably connected to the chamber and a faceplate connected to the front of the enclosure. A sensor system, preferably comprising at least one sensor, is operably coupled to the chamber and sends signals to an electronic control system that is operably connected to the heating element and a user interface provided on the enclosure or faceplate. A drawer is provided and is extendable from the chamber of the warmer and a means for preventing fluids and other contaminants from entering the chamber is also provided for between the enclosure and the user interface and drawer.

The user interface can be, for example an electronic control panel installed one of raised, recessed, and flush with the enclosure and can be constructed out of glass, plastic, metal, rubber or a composite material. The touch panel is preferably sealed and/or coated to protect the electronic controls from being damaged by the elements and to prevent fluids, insects, and other contaminants from gaining entry to the chamber through the touch panel. The touch panel may also include decorative overlays, labels, and trims that are configured for outdoor use. The touch panel may be mounted on the faceplate of the warmer or elsewhere on the enclosure and may be disconnected from the enclosure and used remotely by a wired or wireless controller. In another embodiment, the user interface uses one of a tactile, membrane, piezoelectric, capacitance, resistance, induction system, touch panel, or keypad for the selection of various operations.

The heating element may be included inside, outside, or remote from the chamber. When remotely located, the heating element can be configured to be in communication with the chamber by way of a duct. The warmer may comprise more than one heating element and the heating elements may be attached to or combined with a fan.

The warmer may be incorporated into another appliance such as, for example, a grill and may be either operated in combination with or independent from the appliance. The warmer may also be installed under cabinets or in a wall. Alternatively, the warmer may be used independent of any supporting structure so that it could be moved from place to place. The warmer could also be installed into a mobile island or a similar structure having a working surface and wheels foot pegs, or casters for moving the island from place to place. The warmer is preferably constructed to withstand high temperatures so that it may be installed in, underneath, or around heat-sensitive materials such as wood. Finally, the warmer may be configured to be stackable with like-devices or other appliances so as to conserve space.

The warmer preferably includes a fixed or variable speed fan that is located either in the chamber or remotely. Again, it may also be attached to the heating element or independent of it. The fan is used for mixing air, removing air, or controlling the moisture within the chamber of the warmer.

The warmer preferably includes a venting system that may consist of a plurality of apertures located on the back, bottom, ceiling, walls or front of the warmer. In another embodiment, the venting system includes at least one of an automatic, semi-automatic, or manually controlled aperture closures and a user interface to set, operate, and adjust the aperture closures.

The warmer can be used for non-food or food and drink items alike. Flavoring additives may be added to the chamber so as to impart various flavors or scents to the items being warmed within the warmer.

The warmer is preferably constructed of a material that is resistant to chemicals, high and low temperatures, ultraviolet rays, fluids, and insects.

The warmer preferably includes a lighting element located inside the chamber that may be illuminated when the warmer is opened or when a switch is activated. The warmer also preferably includes a door made of transparent material to aid the user in seeing inside the chamber without having to open the warmer. The door may be connected to the enclosure or drawer by way of a hinge so that the door may be swung open. Alternatively, the warmer may be constructed so that the door could be lifted up or folded down.

Another embodiment of the present invention includes an enclosure. The enclosure consists of sides, a top, and a bottom that define a chamber. In this embodiment, a structure, e.g., a drawer or door, is coupled to the enclosure for movement between a retracted position to warm objects and an extended position. The extended position is at least partially external to the chamber and allows the user to gain access to objects being warmed in the chamber. The structure preferably has a support member for supporting the objects that are to be warmed. A heating system designed to warm the chamber is also provided. A ventilation system for moving and circulating ambient air through the chamber is also provided. Provided on the enclosure is a user interface designed to allow the user to control the temperature within the chamber. At least one seal is preferably provided to prevent liquids and other elements from entering the chamber. Finally, an electronic control system is provided. The electronic control system is coupled to the enclosure and interfaces with the heating and ventilation systems as well as the user interface.

The present invention preferably incorporates a drive system configured to operably move a structure, e.g., a door, enclosure, drawer, or lid, between the retracted and extended positions. A safety device, coupled with the electronic control system and configured to detect a jam of the structure and drive system, may also be provided.

The inventive warmer may also include a timer control that may be programmed by a user to automatically turn off the warmer after a certain amount of time.

The warmer may further comprise a cooling system designed to keep food in the warmer from spoiling. The cooling system can be configured to turn on after a predetermined period of time or once the warmer chamber reaches a particular temperature.

The warmer may also be capable of preset temperatures, preset times, and preset operations.

The warmer's user interface may be configured to display the current time, operations, temperatures, functions, remaining time, diagnostics, features, fan speeds, alarm controls and signals, messages, timed on/off, time delay or be remotely controlled by voice or sound commands from the user.

The warmer may also comprise accessible panels or walls on either its front, side, top, back, or bottom so that a user may gain access to the chamber of the warmer. Furthermore, the warmer may comprise additional warming chambers, e.g., one for food and one for non-food items.

Another embodiment of the present invention includes an enclosure that has sides defining a chamber and a heating system, sensor system, and ventilation system to supply heat and control moisture in the chamber. The sensor system is operably connected to the chamber and configured for detecting at least one of temperature, humidity, items in the chamber, resistance, and power used. The ventilation system is configured for moving air through the chamber preferably with a fan and a plurality of holes on the sides of the enclosure. A structure having a support member to support objects thereon and coupled to the enclosure is also provided. The structure e.g., door, is coupled by at least one guide member for movement between a retracted and extended position. Also provided is a user interface consisting of an electronic touch panel for controlling temperature in the chamber. This embodiment also includes an electronic control system preferably coupled with the heating system, ventilation system, sensor system and user interface to keep the chamber at a desired temperature. Finally, a first and second seal are provided. The first seal provides a barrier to prevent contaminants from entering the chamber and is fixed between the electronic touch panel and the enclosure. The second seal is provided between the structure and the enclosure from preventing moisture from entering the chamber when the structure is in the retracted position.

These, and other aspects and objects of the present invention will be better appreciated and understood when considered in conjunction with the following description and the accompanying drawings. It should be understood, however, that the following description, while indicating preferred embodiments of the present invention, is given by way of illustration and not of limitation. Many changes and modifications may be made within the scope of the present invention without departing from the spirit thereof, and the invention includes all such modifications.

### BRIEF DESCRIPTION OF THE DRAWINGS

The drawings illustrate the best mode currently contemplated of practicing the present invention.

In the drawings:

FIG. 1 is a perspective view of one embodiment of the warmer of the present invention;

FIG. 2 shows an exploded view of another embodiment of the present invention;

FIG. 3 shows a partially exploded view of another embodiment of the present invention;

FIG. 4 shows a rear view of one embodiment of the present invention;

FIG. 5 shows a block diagram of the inputs and outputs of the electronic control system of one embodiment of the present invention;

FIG. 6 is a perspective view of an embodiment of a warmer configured for one of a wall and cabinet installation;

FIG. 7 is a perspective view of an embodiment of a warmer configured for a stacked unit installation;

FIG. 8 is a perspective view of an embodiment of a warmer configured for an under-counter installation;

FIG. 9 is a perspective view of an warmer configured to couple to a stand structure which can be movable, as facilitated by several devices;

FIG. 10 is a perspective view of the front door of an exemplary embodiment of a warming device;

FIG. 11 is a perspective view of an exemplary embodiment of a warming device associated with another appliance and controllable remotely with a remote control unit;

FIG. 12 is a partially exploded view of an exemplary embodiment of a warming device having a drive system.

In describing the preferred embodiment of the invention that is illustrated in the drawings, specific terminology will be resorted to for the sake of clarity. However, it is not intended that the invention be limited to the specific terms so selected and it is to be understood that each specific term includes all technical equivalents that operate in a similar manner to accomplish a similar purpose. For example, the word “connected,” “attached,” “coupled,” and “mounted” and variations thereof herein are used broadly and encompass direct and indirect connections, attachments, couplings, and mountings. In addition, the terms “connected,” “coupled,” etc. and variations thereof are not restricted to physical or mechanical connections, couplings, etc. Such “connection” is recognized as being equivalent by those skilled in the art.

Further, before any embodiments of the invention are explained in detail, it is to be understood that the invention is capable of other embodiments and of being practiced or of being carried out in various ways. Further, the use of “including,” “comprising,” “at least one of,” or “having” and variations thereof herein are meant to encompass the items listed thereafter and equivalents thereof as well as additional items.

### DESCRIPTION OF PREFERRED EMBODIMENTS

The present invention and the various features and advantageous details thereof are explained more fully with reference to the non-limiting embodiments described in detail in the following description.

1. System Overview

The present invention is preferably an appliance or device, for example, including an electronically controlled warmer having an enclosure having sides, e.g., a top, bottom, front, back, left and right walls, a chamber, drawer, door, user interface, faceplate, at least one heating element, a venting system, fan, sensor or detection system, electronic control system and environmental seals. The appliance described herein may be an indoor unit, outdoor unit, mobile unit, an island unit, or a fixed location unit.

As described herein, the warmer or warming drawer preferably comprises a heating element such as a calrod. However, more than one heating element may be used. Alternatively, other heating elements may replace or be used in conjunction with the calrod in the warmer drawer. Other potential heating elements that may be used include: convection heaters, wire heating elements, heat plates, glass film, thermal ceramic heaters, flexible heaters, lights, infrared, inductive, electromagnetic, and radio frequency devices, heat pumps, warming liquids, heat exchangers, axial fan heaters, sonic heaters, and gas and solid fuel products. Electronically controlled heating methods such as radiant, infrared, conduction, inductive, convection, resistance and microwave methods may also be used.

It should be noted that the heating element described herein may be located at various places inside of the chamber of the warmer including inside the side, back, bottom, or top walls of the chamber. Alternatively, the heating elements can also be mounted remote from the apparatus but in communication with, for example, a duct. Using these types of heating elements alone or in combination will increase the heat control and accuracy of the inside temperature of the cavity, thereby achieving even temperatures throughout the chamber. The use of different heating elements can greatly improve on the start-up times and reaching set temperatures faster.

A user interface is provided on the outdoor warmer drawer for control by the user. As described the interface may include an electronic touch panel designed to control the heating elements. Alternatively, knobs, slides, or switches may be used. The user interface can be, for example, piezoelectric, capacitance, tactile (membrane switches), resistance type, padless touch soft switch technology, padless touch digital encoder, infrared frequency dependent, magnetic switches, field effect, charge transfer, Hall Effect, micro encoder, infrared, high frequency, inductive computer key board, computer screen, sound, radio frequency, or induction touch panel (keypad) for use by the operator. Such controls can be installed on the warmer flush, recessed, or raised and coupled. Electronic controls can be placed on any surface so as to accommodate any design for matching other products. The electronic touch panel may be made of glass, metal or plastic with selection of the operating function(s) made by touching the surface of the glass, metal, plastic or of other substrates to operate the warming apparatus. The panel may also have membrane, tactile, resistance, and/or capacitance switches with decorative overlays, labels, and trim. Touch control keypad panels can be installed flush, raised, recessed, or remotely on any plane with the use of electronics. Remote control can be by wire or by wireless means so that the electronic controls may be placed on any surface to accommodate any design or for matching other products. Any of these types of user interfaces may be fitted with decorative overlays, labels, and trim so as to interface with the user.

The use of electronics is disclosed herein. For example, these include micro-controllers, microprocessors, integrated circuits and drivers, PC Boards, processors, and power circuits may be used to better control functions, operations, and temperatures and may be factory preset so as to limit the user to simple on and off operation of the unit. The overall size, design, look, and feel of the warmer can be matched to the size, design, look, and feel of any appliances associated with the warmer.

Electronic controls are generally sealed better than mechanical controls, and therefore electronic controls are less susceptible to degradation when exposed to the elements. Electronics also reduce the unit size so that the inventive warmer may now be used in a number of places where present units cannot.

The electronic controls described herein may be configured to allow for timed on/off control based on one or more sensors or controls such as temperature, moisture control, electronic sensors, programmable/selectable set point(s), programmable/selectable set time(s), programmable/selectable set operation(s), and programmable/selectable set temperature(s).

The user interface may also be controlled remotely, e.g., having the control device located not on the warmer but in a different location. Remote control can be by a wired or wireless device using a, for example, infrared signal for controlling the functions and operations of the warmer. Other forms of wireless communication such as Zigbee or RF may also be used. Remote control may include one-way or two-way communication. In one embodiment, the remote control is configured to support two-way communication between the user interface and a remote device so that the remote device receives signals from the warmer and displays information such as the current setting or temperature. The use of electronics provides for better control and offers more operations than can be had in a mechanically controlled device. The warmer may also be configured with factory preset operations, functions, and temperatures.

The warmer drawer preferably includes an electronic control system operably coupled with the user interface and the heating element. The electronic control system preferably will control the heating element in response to a signal from the user interface so that the operator may be able to maintain the appropriate temperature within the chamber.

The electronic control system described herein is designed to better regulate the electrical current supplied to the heating element. By improving the accuracy of the current supplied to the heating element, control of the heat output to the chamber is improved, and thus the accuracy of the temperature in the chamber is also improved. By improving the accuracy of the temperature within the chamber, the quality of, for example, food items in the warmer is also improved. PTC (Positive Temperature Coefficient) sensor technology is one method for controlling or regulating the current supplied to the heating element. PTC technology provides better control over the current supplied to the heating element and thus greatly reduces the need to continuously cycle power on and off to regulate temperature. As such, temperature over and undershoots are greatly reduced, and the time required to heat the chamber to the proper temperature is also reduced. PTC technology is but one method of controlling the current supplied to the heating element, and it should be noted that other methods are contemplated.

A fan is disclosed herein. In general, the fan is for circulating air throughout the chamber and controlling humidity build-up is preferably present. The fan may be used with or without a heating element attached to it. It can be secured to the inside of the chamber or remotely located but in fluid communication with the warmer. The fan may be used to circulate air and will provide better heat control and response time. By circulating air, hot spots or stratified layers of varying temperature within the chamber are eliminated. Improvements to the cavity temperature help to eliminate the temperature swings inside the chamber, thus providing better control and eliminating the need for user control. The fan may be a fixed or variable speed fan.

A motorized, electromagnetic, solenoid or powered venting system may also be provided. The venting system is preferably configured to optimally control the temperature, humidity, and airflow of the chamber. Sensors or a system of sensor may be utilized to determine the humidity or temperature in the chamber and to send a signal to the electronic control system reporting the sensed humidity or temperature. The venting system, in response to a signal from the electronic control system, may open or close the vents to regulate the conditions within the chamber. The venting system may further comprise mechanical louvers, slots, apertures, closures, or holes for controlling the moisture in the chamber. The venting may be located in the back, bottom, ceiling, walls, or front faceplate.

A means for sealing the inside of the chamber from the elements is preferably present to facilitate use of the warmer outdoors. The means for sealing may be by way of hermetically sealing the chamber from any environmental contaminants. Hermetic sealing involves the use of an airtight seal or coating means in order to secure the chamber from outside contaminants such as fluids, insects, and other environmental contaminants. Alternatively, the sealing means could consist of a system of channels designed to channel such contaminants away from the chamber and toward the outside of the warmer.

The sealing means may also include gaskets, adhesive tape, double sided tape, RTV, glues, epoxies, silicon gels, foam, rubber shapes, and other materials. Welding may also be used to seal the warmer. The device preferably has at least one weather-tight seal between the door and the frame preventing environmental contaminants from entering the chamber and/or damaging any of the electronics located within the device. Seals may be located anywhere else on the device where there may be gaps present that would allow fluids or other environmental contaminants from entering the chamber.

Additionally, sealing of the electronic components and user interface is accomplished with coatings, for example, that cover the electronics, electronic boards, and or other components.

One or more sensors for the warmer are also described. These may be used to sense various environmental conditions. In one embodiment, a sensor scans the warmer for an item placed therein. It may also provide feedback to the device's electronic control system to operate a fan. Sensors for the appliance may be also used to detect at least one of: airflow, smoke, temperature, speed, power, resistance, voltage, programmed operations, and set points. The use of sensors and sensor systems will allow for more control over the environment inside the chamber, thus regulating and maintaining proper temperature and humidity levels. Maintaining proper temperatures can prevent food objects placed in the warmer from drying out. Additionally, non-food items placed in the drawer, such as towels, can benefit from being stored at the proper temperature and humidity levels.

In one embodiment, a scanning infrared detection system could be placed in the chamber of the warmer to detect the temperature of the contents of the chamber. In one embodiment, thermopile (pyrometry) and thermopile infrared sensors are used. Various other sensors could be used, but are not limited to, those such as a thermostat, thermal disk, thermal protector, thermal cutoff, electronic temperature controller/sensors, electronic/mechanical AC or DC sensor/control devices, temperature sensors, thermal switch, thermal couples, bulb and capillary, electronic controls, bimetallic, pressure switches, creed action thermostats, resistance temperature detectors, controllers, manual resets, automatic resets, disc thermostat, snap action switch, negative temperature coefficient of resistance thermistors, and power positive temperature coefficient of resistance thermistors.

The warmer described herein preferably has a movable drawer that can be constructed in a number of different ways. For example, the drawer can use guide members coupled to the chamber of the device for retracting and extending the drawer. The guide members are connected to a movable frame that facilitates the retraction and extension of the drawer. Alternatively, one could use slides, glides, formed grooves, rollers, ball bearings, bearing pads, or other methods of guiding the drawer into the chamber. In another embodiment, the drawer can be directly coupled to the guide members without the use of movable frame. In this embodiment, the drawer is simply placed in and out of the chamber by fitting the drawer to the guide members. The drawer could also be replaced with a rack, plate, glass plate, glass plate with a heat coated surface, or other material capable of supporting food and non-food items in the chamber. In still another embodiment, food or item to be heated (or cooled) is placed inside the cavity without the benefit of any supporting structure, e.g. like a microwave oven.

The enclosure or door assembly described herein preferably comprises a front vertical panel, a back vertical panel, a vent slide item, a vent seal mesh, a barrier mesh, a door seal, and a frame. The front panel can be constructed so as to match whatever appliance the warmer device will be combined with or installed into. A barrier item is used in between the front and back of the door to prevent insects from entering, e.g., through the vent holes. The seal is used to eliminate gaps in which fluids and insects may enter. The back can be attached to the movable frame. The door front is preferably designed to channel any fluids or other environmental contaminants away from the device. In one embodiment, the front of the door assembly is coupled to the front of the drawer. In another embodiment, the vertical drawer front is constructed to fold away so that it is not pulled out with pan. In yet another embodiment, the warmer drawer door can be hinged rather than fixed to the drawer structure. The door may then be swung out of the way in a bi-fold manner or as two doors swinging open from the middle. Alternatively, the door may be retractable as a single door or a door comprised of multiple segments.

The disclosed warmer can also be used in combination with another existing appliance. For example, it can be configured to combine the functions of a mini-oven, boiling cavity, microwave oven, baking drawer, toaster oven, cooking drawer, pizza oven drawer, steaming drawer, broiler oven, or any other appliance and preferably uses the same electronic controls to control the various functions. Combining the warmer with other heating and cooking products can reduce the amount of space the user needs. Additionally, using dual or multiuse cooking compartments rather than large ovens can save users on electricity costs due to their small size and low power requirements.

Additionally, the device could be modularly constructed so that the warmer may be installed into a grill or other outdoor appliance without being actually built into it. The modularly constructed warmer could also be configured so that it may be used independently of that which it has been combined with.

The device is preferably made with high-heat construction so that it can safely be installed into or along side cabinets or walls constructed of wood or other materials susceptible to degradation when coming into contact with heat. The device can also be constructed so that it is a freestanding or standalone unit not requiring a structural frame or cabinet. Preferably, the device is constructed of a material resistant to chemicals, high and low temperatures, ultraviolet rays, fluids, and insects.

The device preferably consists of a warmer with a lighting element located inside the chamber to provide illumination. The lighting element is preferably configured to illuminate upon opening and/or upon the turning on of a switch. The lighting element can consist of any type of lighting device capable of withstanding the temperatures within the chamber. Because warmers are typically placed low to the ground, it is typically difficult to see the objects inside the chamber. The use of the lighting element will greatly increase the operator's ability to see inside the chamber. This may be aided through the use of glass or transparent doors on the front of the device.

The disclosed warmer may also be equipped with at least one of: a LED display, a LCD display, an illuminated display that can be adjusted in color and intensity, a plasma display, a dot matrix display, line segment display, and a vacuum fluorescent display may be used for displaying of information such as functions, temperature, humidity, and times. Sealed construction is preferably used. The display device preferably displays at least one of operations, temperature, functions, range position, diagnostics, features, fan speeds, alarm controls, messages, on/off timer, timed delays, cool temperature, and the current time. The display may be mounted on one of a fixed faceplate, moveable faceplate, or door and may be configured so as to be removable from the warmer. In one embodiment, the display is configured so as to pop-up from a hidden position. In another embodiment, the display is rotatably mounted with a protective cover to protect the display. In another embodiment, the display is retractably mounted incorporating sliding panels for protecting the display from the environment. In another embodiment, the display is configured to illuminate and has adjustable color and intensity settings.

In another aspect of the present invention, the display is operably coupled to the user interface so that changes made by the user to the operations, settings, functions, temperatures, times, and other settings are displayed to the user.

The warmer device may be used for warming food and non-food items alike. When used for warming food, the device can be used in combination with flavoring additives that may be placed in the chamber or drawer to add flavor to the food in the chamber. Non-food items such as drinks or towels may also be warmed in the device.

In one embodiment, the device consists of multiple warming chambers within the same outdoor warmer. The other warming chambers preferably have independent temperature control or preset temperature points.

In another embodiment, the warmer can be built into a mobile island or cart so that it may be moved from place to place. The mobile island or cart can also comprise a working surface where an operator can cut food or perform other work. The working surface is preferably made out of metal, wood, man-made or natural material, or some other surface material capable of being used outdoors. The mobile island or cart could be constructed with drawers, slides, or doors for cooking and holding food and non-food items. In this embodiment, the device is a heated chamber appliance that is accessed by doors, drawers, or lids and rests on the ground or other surface by way of foot pegs, legs, wheels, or casters. Additionally, the mobile island or cart could be pre-configured so that installation is not required.

Programmable set points, times, timers, temperatures, on/off settings, and operations are another aspect of the present invention. The electronic control system, through signals preferably received from the user interface, can operate and control the programmable settings. The use of an electronic control system offers an advantage over a mechanical system where the user would not be able to program such settings.

In yet another embodiment, the device may further comprise a cooling system designed to cool the objects stored in the warmer after a predetermined period of time. In one embodiment, the warmer can be built with a heating and cooling element. This allows the warmer to not only maintain a set temperature, but also to refrigerate the contents of the warmer after a predetermined time to prevent spoilage of food items. Heat pumps, magnetic cooling, electronic cooling circuits, or other cooling methods may be incorporated in the drawer. The relatively small size of the warmer will provide the user with considerable energy and space savings over the use of separate appliances to warm and cool items.

In one embodiment, the device may have a timed on/off control so that the device is automatically turned off after a predetermined period of time.

In still another embodiment, the warmer is configured to be stackable with like-devices. Preferably, such warmers are constructed so that if a user requires more than one warmer, the user may stack all of the warmers on top of one another to save on space.

In another embodiment, the warmer is configured with factory-preset times, points, operations and temperatures. In this embodiment, the device simply comprises an on/off switch or control and no other user interaction is necessary to operate the warmer.

In yet another embodiment, the device is configured to respond to voice or sound commands from an operator.

2. Detailed Description of the Preferred Embodiments

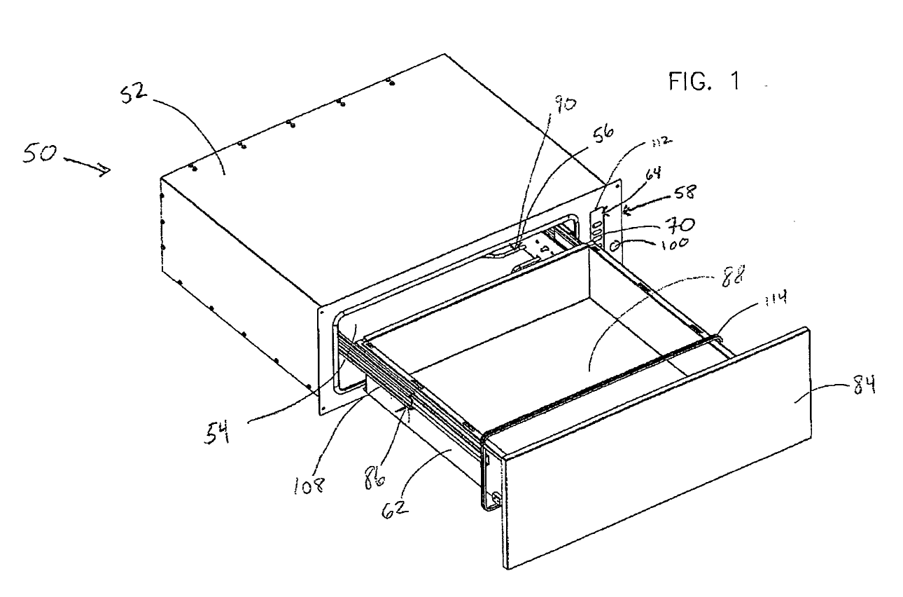

Various embodiments of the device of present invention are shown in FIGS. 1-11, which are described in additional detail below. All of these embodiments are configured from the same basic design and like reference numerals refer to like components.

FIG. 1 shows one preferred embodiment of device 50 of the present invention. Now referring specifically to FIG. 1, device 50 is preferably a warmer or warming device or drawer that includes an enclosure 52 defining a chamber 54. Heating elements 56 are preferably mounted on the bottom of the chamber. The heating elements 56 are preferably calrod heating elements.

A structure 86 is preferably provided to allow access to the chamber 54. The structure 86 preferably includes a drawer 62 and at least one support member 88 for supporting objects thereon. The drawer structure 86 is preferably coupled to the enclosure 52 for movement between a retracted position to warm the objects in the chamber 54 and an extended position (as shown) so that an operator may access the inside of the chamber 54. The device 50 preferably includes seals 114 between the drawer structure 86 and the enclosure 52. The seals 114 preferable prevent fluids and other environmental contaminants from entering the chamber and also prevent heat and gases from escaping the chamber (unless so desired). The drawer structure 86 further comprises at least one guide member 108 to move the drawer structure 86 between the retracted and extended positions.

Also shown in FIG. 1 is a user interface 64. The user interface 64 preferably comprises an electronic touch panel 70. The electronic touch panel 70 is preferably made out of a durable, natural or man-made material and coated to seal and protect the panel 70 from the elements. The electronic touch panel 70 preferably further comprises a seal 112 between the panel 70 and the enclosure 52 to prevent fluids, moisture, and other environmental contaminants from entering the chamber 54. In one embodiment the user interface 64 further comprises knobs, slides, or switches for operating the warmer drawer 50. The user interface may also include a remote control device 74 capable of interaction with the user interface from a remote location. The remote control device 74 can be either wired or wireless. In another embodiment, the user interface 64 may be removable from the device 50. The interface 64 may be configured to show or alternatively be hidden when the drawer is closed.

Also shown in FIG. 1 is a faceplate 58 coupled to the front of the enclosure 52. The user interface 64 is preferably installed on the faceplate 58. It can be flush, recessed, or raised. The faceplate 58 further provides at least one seal 114 for preventing fluids, moisture, and other environmental contaminants from entering the chamber 54.

At least one door 84 is also preferably provided on the device 50. The door 84 can be constructed of any suitable material. In one embodiment, the door 84 comprises a transparent material so that a user may see inside the chamber 54 without moving the drawer 62 to the extended position, thus keeping the objects in the chamber 54 warm. In another embodiment, the door 84 is hinged so as to be swingably openable.

A timer control 100 is preferably provided on the enclosure 52 of the device 50. The timer control 100 is capable of being set so that the warmer drawer device 50 will be automatically powered off after a user-defined preset elapsed time. In another embodiment, the timer control 100 is programmable to automatically turn on after a certain period of time. In yet another embodiment, the timer control 100 is programmable to set different periods of time to perform predefined operations of the warmer drawer 50.

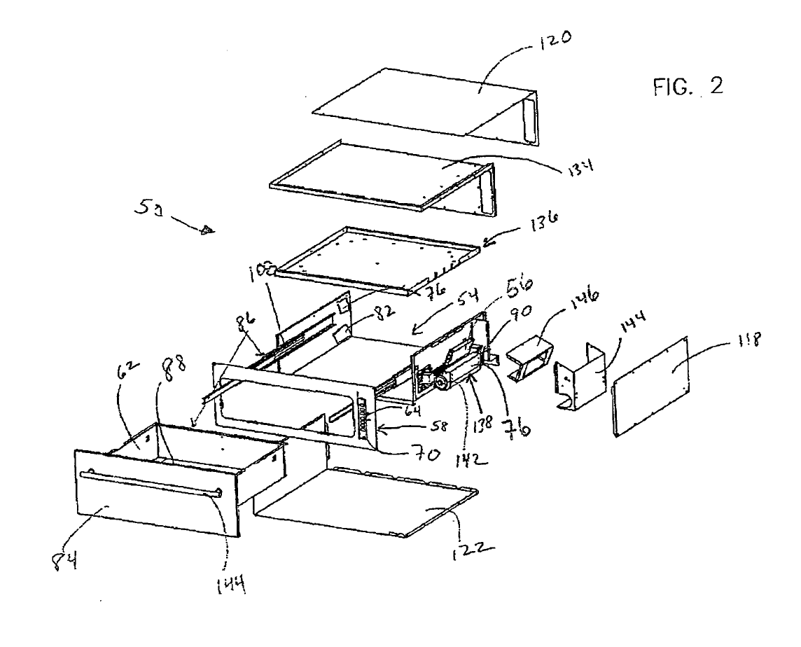

FIG. 2 shows an exploded view of another, but similar, embodiment of the present invention. In FIG. 2, the device 50 also includes an enclosure 52 that comprises an enclosure top 120, enclosure bottom 122, and enclosure sides 118. In one preferred embodiment, the enclosure 52 is built with double-wall construction so as to further reduce the amount of heat given off by the device 50. In this embodiment, internal wrap 134 is provided between the enclosure top 120 and ceiling 136. Also present is heating element housing 138, which houses heating element 56. Covering the heating element housing 138 are internal housing cover 146 and external housing cover 148. Also provided is a structure 86 with a drawer 62 having a support element 88. On the door 84, a handle 140 to facilitate the retracting and extending of the structure 86 is provided.

In another embodiment, a fan 76 configured to circulate the air throughout the chamber is preferably provided on the warmer. The fan 76 may be located either in the chamber 54 or remotely and may be either a fixed or variable speed fan. The fan 76 can be used for at least one of removing air, mixing air, and controlling moisture in the chamber 54. In another embodiment, a fan 76 is attached to the heating element housing 138 and working in combination with the heating element 56.

A lighting element 82 is also shown in FIG. 2. The lighting element 82 is preferably configured to supply light to the chamber 54 when the door 84 is opened. In another embodiment, the lighting element 82 is illuminated upon the activation of a switch. The lighting element 82 can be any standard lighting device capable of withstanding the temperatures within the chamber.

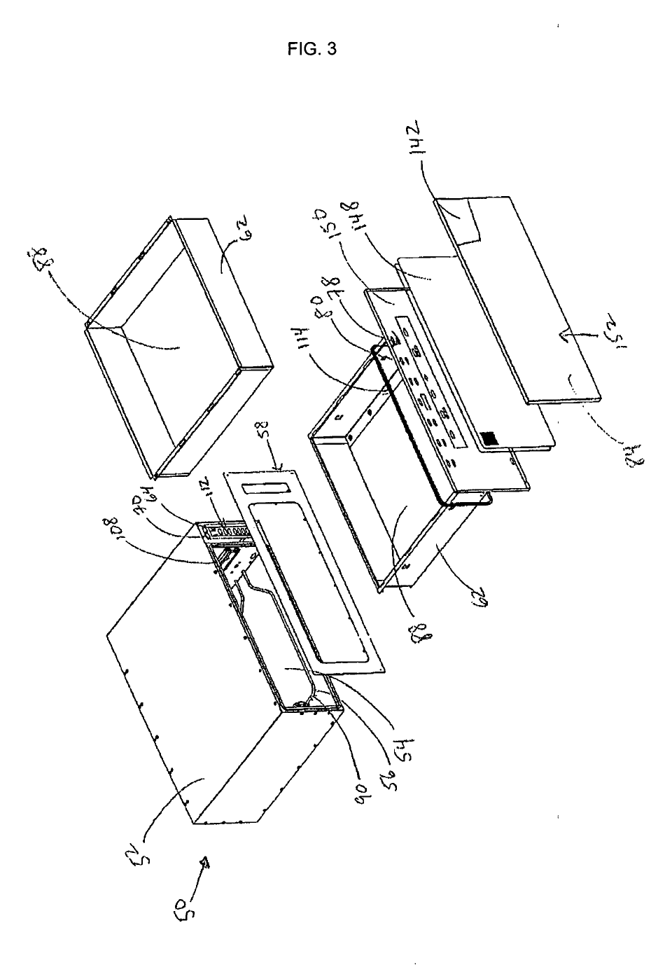

FIG. 3 shows a partially exploded view of another embodiment of an outdoor warmer drawer 50. The outdoor warmer drawer 50 shown in FIG. 3 includes a venting system 78 comprised of apertures 80 located on the back vertical plate of the door assembly 84. Apertures 80 can also be located on the back, bottom, ceiling, walls, or front, e.g., in the faceplate, of the device for ambient airflow. The venting system 78 further comprises a means for closing off the apertures 80 by a motor driven vent slide, solenoid, electromagnetic, or other electronically controlled device. In another embodiment, the venting system 78 includes at least one of an automatic, semi-automatic, or manually controlled aperture closures 80. The user interface 64 is preferably configured to set, operate, and adjust the aperture size.

In one embodiment, the apertures 80 are located on the back vent plate 150 of the door assembly 84. In this embodiment, the door assembly 84 preferably further comprises an internal mesh barrier 148 and a front plate 152. The mesh barrier 148 is located between the back vent plate 150 and the front plate 52. The mesh barrier 148 provides further protection from insects and the like that may try to enter the chamber 54 through the door assembly 84.

FIG. 3 also shows a display 142 provided on the front plate 152 of door assembly 84. The display is preferably one of a LED, LCD, illuminated, plasma, dot matrix, line segment, or a vacuum fluorescent display and is preferably configured for showing operation, function, speed, and time. The display may be located either on the door assembly 84, as shown, or alternatively, may be provided on the faceplate 58 or enclosure 52.

FIG. 4 shows a rear view of the warmer 50. An access panel 104 with venting apertures 80 is shown in this figure. Access panel 104 can be on at least one of the front, side, top, back, and bottom of the warming drawer 50 and can be used to allow an operator to gain access to the inside of the device 50 or chamber 54.

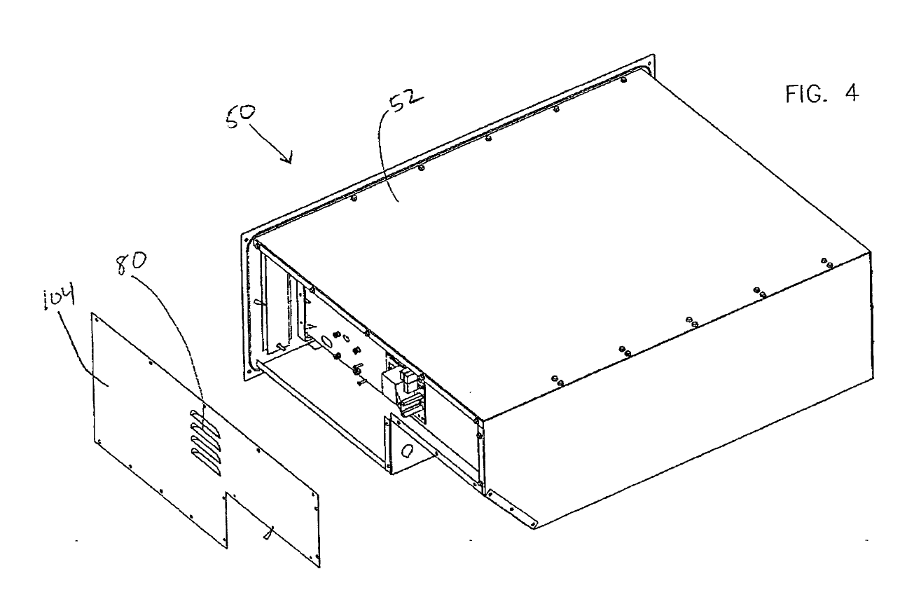

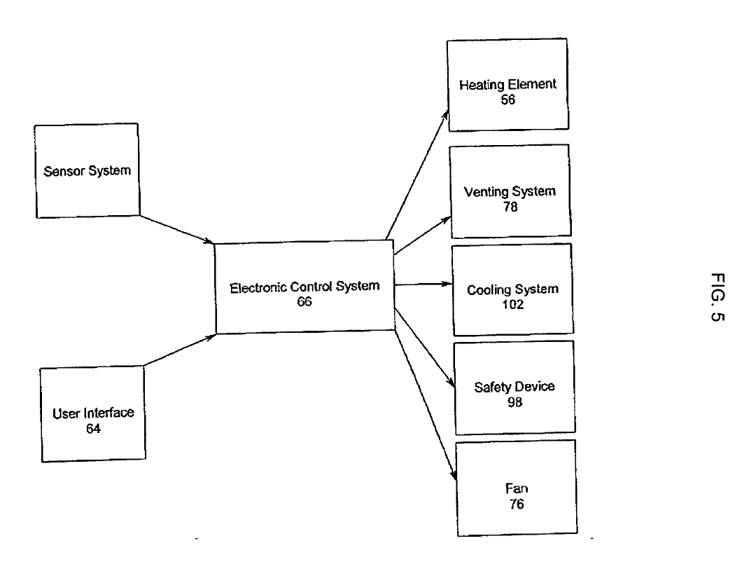

FIG. 5 shows a flow chart of the possible inputs and outputs for the electronic control system 66 for one embodiment of the present invention. The electronic control system 66 is provided on the outdoor warmer drawer 50 and is coupled to the user interface 64 and the heating elements 56. The electronic control system 66 responds to signals from the user interface 64 to control the heating elements 56 and regulate the temperature within the chamber 54. The electronic control system 66 is preferably connected to a ground fault interrupt circuit on the power cord or main line (not shown). The drawer structure 86 preferably further comprises a drive system 96 that is controlled by the electronic control system 66 and is capable of moving the drawer structure between the retracted and extended positions. The drive system 96 is operated by the user through the user interface 64, which in turn sends a signal to the electronic control system 66 to activate the drive system 96. The electronic control system 66 is preferably coupled with a safety device 98 designed to detect a jam of the drawer 62 and upon detection of a jam stop the operation of the drawer.

In one embodiment, the electronic control system 66 responds to signals sent from the sensor system 60 to regulate the conditions of the warmer drawer 50. For example, if the sensor system detects that the temperature within the drawer is too high, the electronic control system 66 can respond by reducing the power supplied to the heating elements 56, thus reducing the temperature within the chamber 54. The sensor system 60 preferably consists of at least one sensor located within the chamber 54 or remotely from the chamber 54 but in communication with the chamber 54. The sensors of the sensor system 60 are preferably used for detecting the temperature, the presence of items and objects in the warmer drawer cavity or chamber 54, resistance, and power used by the device 50. The electronic control system 66 preferably also regulates the fan 76 and venting system 78 in response to signals from the sensor system 60 that the chamber 54 requires more or less airflow.

The electronic control system 66 is also preferably configured to operate a cooling system 102. The cooling system 102 can be configured to cool the temperature within the chamber 54 in response to a signal from the electronic control system 66. In this embodiment, a sensor of the sensor system 66 sends a signal to the electronic control system 66. The electronic control system 66 may also be configured to cool the chamber 54 after a predetermined amount of time to prevent spoilage or after the chamber reaches a particular predetermined temperature. The predetermined time or temperature can be factory preset or user defined by use of the user interface 64. Separate shelves or compartments within the appliance may be used for cooling, storing, and/or heating.

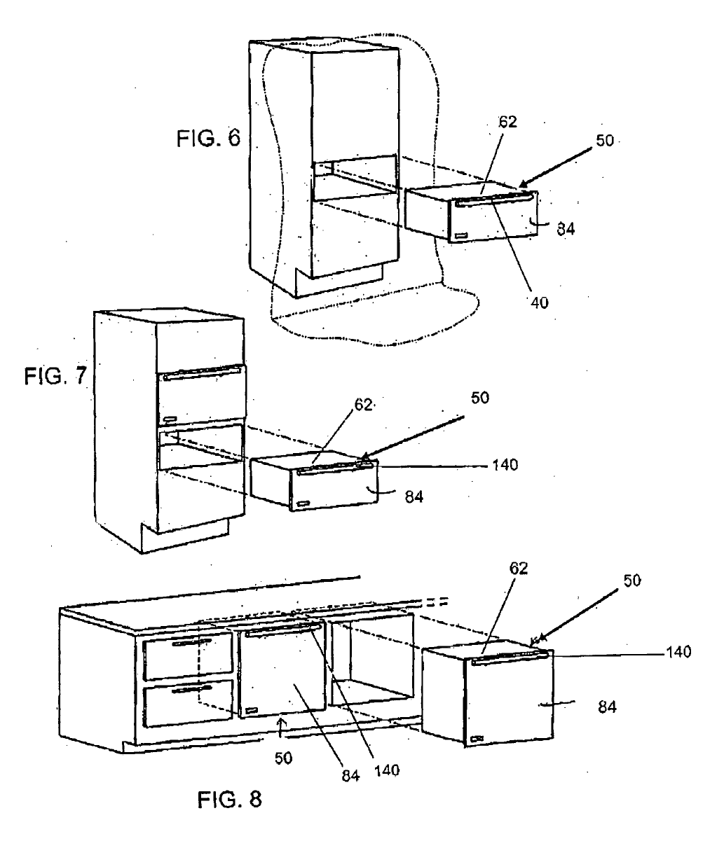

FIGS. 6-8 show several different embodiments that combine the warmer with another support structure. FIG. 6, for example, shows the warmer drawer 50 installed within either a wall or cabinet. FIG. 7 shows the unit installed into a stacked installation. The warmers 50 may be configured to facilitate stacking with like units or with other appliances. By stacking the warmers 50 in one location, space is saved giving users a larger area in which to do other tasks

FIG. 8 shows an installation of the warmer 50 underneath a cabinet. As shown in the drawing, multiple warmers 50 may be inserted underneath cabinets. In each of these embodiments, handles 140 can be located on the front of the door 84 to facilitate opening and closing the drawer 62. In another embodiment, the doors 84 can be made of a transparent material to allow a user to view the inside chamber 54 of the warmer 50.

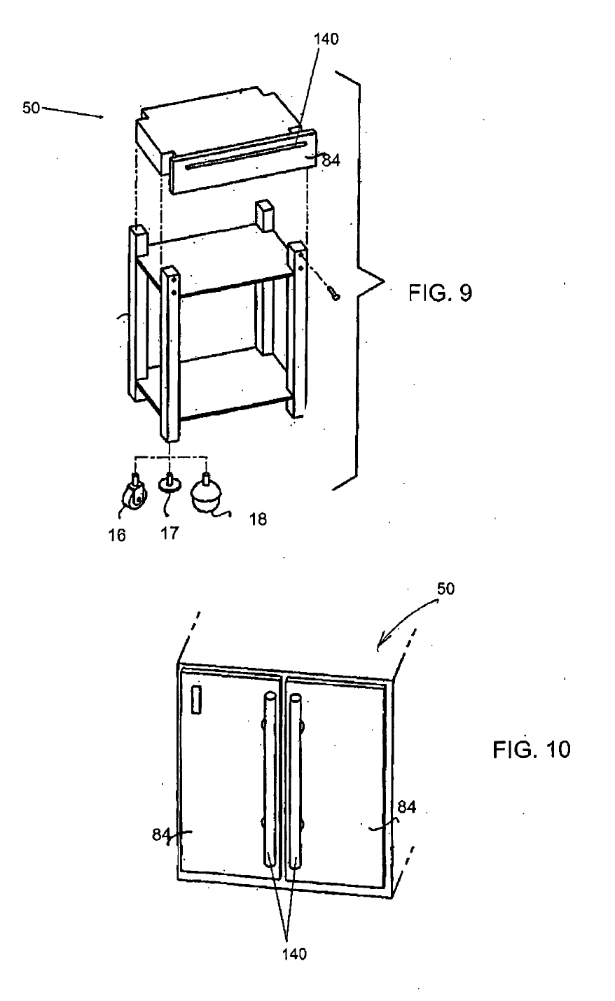

Referring now to FIG. 9, another embodiment of the present invention is shown in which the warmer 50 is installed in a support structure such as a mobile island. The support structure facilitates movement from place to place by use of at least one of wheels 128, foot pegs 130, and casters 132. Installing the warmer 50 on a mobile structure, as shown, will allow a user to move the warmer to a plurality of locations. In another embodiment, a work surface is provided on the mobile island.

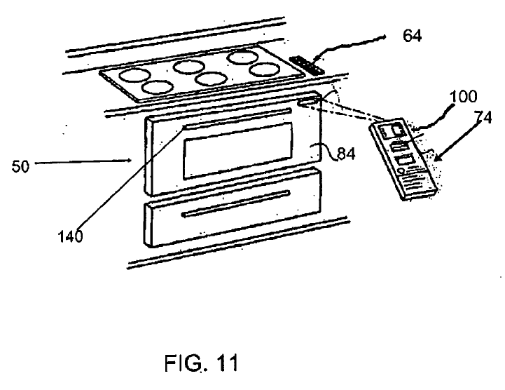

FIG. 10 shows another embodiment of the present inventive warmer 50. The warmer 50 shown in FIG. 10 has a set of doors 84 that are hingedly attached to the enclosure 52 so that they may be swung open from the center of the warmer 50 by using handle 140.

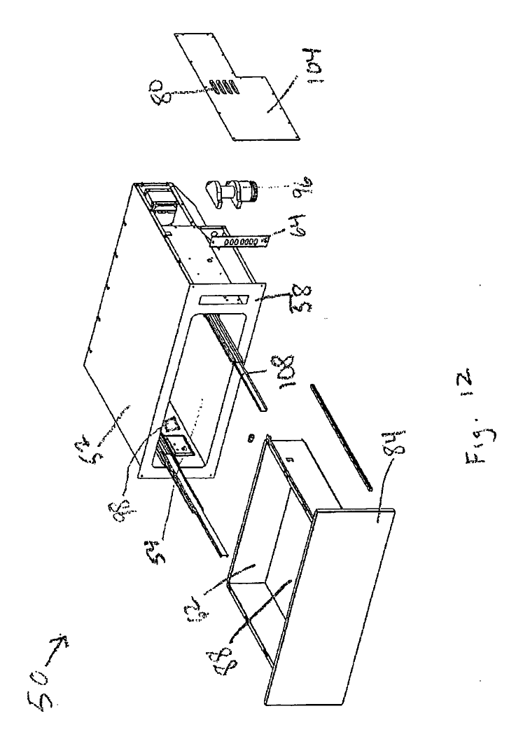

Referring to FIG. 11, a user interface 64 is shown according to one embodiment of the present invention. The warmer 50 is installed with another appliance as shown. User interface 64 is intended to permit convenient operation of the warmer 50 by a user. A remote control device 74 is provided for remote operation of the warmer 50. The remote control 74 may be configured with a timer control 100 as well as controls for temperature and humidity.

Referring to FIG. 12, a drive system 96 is operably coupled to the warmer 50 and the structure 86 to facilitate movement of the drawer 62 between a retracted and an extended position. A safety device 98 is additionally operably coupled to the drive system 96 and structure 86. The safety device 98 detects the occurrence of a drawer jam and disables the drive system 96 so as to prevent movement of the structure 86.

There are virtually innumerable uses for the present invention, all of which need not be detailed here.

Although the best mode contemplated by the inventors of carrying out the present invention is disclosed above, practice of the present invention is not limited thereto. It will be manifest that various additions, modifications, and rearrangements of the features of the present invention may be made without deviating from the spirit and scope of the underlying inventive concept. In addition, the individual components need not be fabricated from the disclosed materials, but could be fabricated from virtually any suitable materials. Moreover, the individual components need not be formed in the disclosed shapes, or assembled in the disclosed configuration, but could be provided in virtually any shape, and assembled in virtually any configuration. Further, although various components as described herein as physically separate modules, it will be manifest that they may be integrated into the apparatus with which they are associated. Furthermore, all the disclosed features of each disclosed embodiment can be combined with, or substituted for, the disclosed features of every other disclosed embodiment except where such features are mutually exclusive.

It is intended that the appended claims cover all such additions, modifications and rearrangements. Expedient embodiments of the present invention are differentiated by the appended claims.

We hereby claim:

1. An outdoor warming device comprising:
an enclosure defining a chamber;
a heating element operably connected to the chamber;
a faceplate connected to the enclosure;
a sensor system operably connected to the chamber;
a drawer selectively extendable from the chamber;
a user interface operably connected to the enclosure;
an electronic control system operably connected to the heating element and the user interface; and
a means to prevent fluids and other environmental contaminants from entering the chamber.

2. The outdoor warming device of claim 1, wherein the user interface comprises an electronic touch panel installed on the enclosure so as to be at least one of flush, raised and recessed on the enclosure, and the electronic control system is configured for controlling operation of the heating element in response to a signal from the user interface so that an object in the chamber is maintained at a pre-determined temperature.

3. The outdoor warming device of claim 2, wherein the touch panel is comprised to be at least one of: glass, plastic, metal, rubber and a composite material.

4. The outdoor warming device of claim 2, wherein the touch panel is sealed to prevent fluids and other environmental contaminants from entering the chamber by way of the panel and is coated so as to protect the touch panel from outdoor elements.

5. The outdoor warming device of claim 2, wherein the panel uses decorative overlays, labels, and trims configured to be used outdoors.

6. The outdoor warming device of claim 2, wherein the touch panel is configured so as to be mounted on the faceplate of the device.

7. The outdoor warming device of claim 2, wherein the touch panel can be selectively disconnected from the device.

8. The outdoor warming device of claim 1, wherein the user interface may be controlled by a remote control device.

9. The outdoor warming device of claim 1, further comprising at least one additional heating element.

10. The outdoor warming device of claim 1, wherein the heating element may be included inside, outside, or remote from the chamber.

11. The outdoor warming device of claim 1, wherein the device can be installed in an outdoor appliance and either operated separately or in combination with the appliance.

12. The outdoor warming device of claim 1, wherein the device is configured to be installed at least one of under and along side cabinets or built into a wall.

13. The outdoor warming device of claim 1, wherein the user interface is configured to display at least one of current time, time remaining, operations, functions, diagnostics, features, fan speeds, alarm controls and signals, messages, on/off timer, delay time, and temperature in the chamber.

14. The outdoor warming device of claim 1, wherein the device is configured to withstand high temperatures so that the device may be mounted into wood or other materials susceptible to degradation when coming in contact with heat.

15. The outdoor warming device of claim 1 wherein the device is configured with at least one of a preset temperature points or ranges, functions, and operations that cannot be changed by a user.

16. The outdoor warming device of claim 1 further comprising a fan configured to circulate air in the chamber; the fan can be located either in the chamber or remotely but in communication with the chamber; the fan can be either a fixed or variable speed fan; and the fan is configured to do at least one of removing air, mixing air, and controlling moisture within the chamber.

17. The outdoor warming device of claim 1 further comprising a venting system for controlling moisture, airflow, and temperature in the chamber.

18. The outdoor warming device of claim 17 wherein the venting system comprises a plurality of aperture closures that are manually or automatically activated.

19. The outdoor warming device of claim 18 wherein the aperture closures can be located in a back, bottom, ceiling, walls, or front of the device.

20. The outdoor warming device of claim 1 wherein the device is configured to be stackable with a plurality of appliances.

21. The outdoor warming device of claim 1 wherein the chamber is configured to allow use of flavoring or scent additives in the chamber so as to add flavor to food in the chamber.

22. The outdoor warming device of claim 1 wherein the device is configured to be resistant to chemicals, high and low temperatures, ultraviolet rays, fluids, animals and insects.

23. The outdoor warming device of claim 1 wherein the electronic control system is connected to a ground fault interrupt circuit on a power cord or on a main line.

24. The outdoor warming device of claim 1 further comprising a lighting element located inside the chamber; and an electronic control for controlling illumination of the lighting element.

25. The outdoor warming device of claim 24 wherein the lighting element is illuminated upon removing the drawer from the chamber.

26. The outdoor warming device of claim 1 further comprising a door made of a transparent material so that a user may see inside the device.

27. The outdoor warming device of claim 26 wherein the door is opened by at least one of a selectively hinged and sliding configuration.

28. A warming device comprising:
an enclosure having sides defining a chamber;
a structure having at least one support member to support objects thereon, the structure coupled to the enclosure for movement between a retracted position to warm the objects within the chamber and an extended position at least partially external to the chamber to permit access to the objects inside by a user;
a heating system for heating the chamber;
a ventilation system for moving air throughout the chamber;
a user interface for controlling the temperature in the chamber;
at least one seal for preventing liquid and other environmental contaminants from entering the chamber; and
an electronic control system coupled to the enclosure and interfacing with the heating system, ventilation system, and user interface so that the objects can be maintained at a desired temperature.

29. The warming device of claim 28 further comprising a drive system operably connected to the electronic control system and structure for moving the structure between the retracted and extended positions.

30. The warming device of claim 29 further comprising a safety device coupled with the electronic control system and structure configured to detect a jam of the structure and prevent further movement of the structure in the case of a jam.

31. The warming device of claim 28 wherein the device is configured to be installed in a mobile cart having a top work surface and at least one of wheels, casters, and foot pegs for movement of the cart.

32. The warming device of claim 28 wherein the device is configured to be mobile so that it may be used independent of a structural frame.

33. The warming device of claim 28 further comprising a cooling system such that food kept in the device will be cooled to preserve the food and prevent spoilage.

34. The warming device of claim 28 wherein the device has capabilities for at least one of: preset temperatures, preset times, and preset operations.

35. The warming device of claim 28 wherein the user interface is configured to display the current time.

36. The warming device of claim 28 wherein the device is configured to be controlled by sound commands from a user.

37. The warming device of claim 28 wherein a user configures the user interface to display user defined messages.

38. The warming device of claim 28 further comprising at least one of panels and walls on at least one of a front, side, top, back or bottom of the device so that a user may gain access to the chamber.

39. The warming device of claim 28 further comprising at least one additional chamber for at least one of cooling, storing, and heating items in the chamber.

40. The warming device of claim 28 further comprising at least one separate shelf inside the chamber for at least one of cooling, storing, and heating items in the chamber.

41. The outdoor warming device of claim 1 wherein the drawer is extendable from the chamber and movably coupled to the enclosure by at least one guide member.

42. An electronically controlled warmer comprising:
an enclosure having sides defining a chamber;
a heating system for supplying heat to the chamber;
a sensor system operably connected to the chamber for detecting at least one of: temperature, items in the chamber, humidity, resistance, and power used;
a structure having at least one support member to support objects thereon, the structure coupled to the enclosure by way of at least one glide member for movement between a retracted position to warm objects within the chamber and an extended position at least partially external to the chamber to permit access to the objects by a user;
a ventilation system for moving air throughout the chamber wherein the ventilation system comprises a fan operably connected to the chamber and a plurality of apertures on at least one of: the top, front, back, bottom, and sides of the enclosure;
a user interface provided on the enclosure comprising an electronic touch panel for controlling the temperature in the chamber;
an electronic control system coupled to the enclosure and interfacing with the heating system, ventilation system, sensor system and user interface to maintain the chamber at a desired temperature;
a first seal between the electronic touch panel and the enclosure for preventing moisture and other environmental contaminants from entering; and
a second seal between the structure and the enclosure for preventing moisture and other environmental contaminants from entering when the structure is in the retracted position.

43. The electronically controlled warmer of claim 42 further comprising a display for showing operation, function, speed, or time; a LED, LCD, line segment, illuminated, plasma, dot matrix, or a vacuum fluorescent mechanism.

44. The electronically controlled warmer of claim 42 wherein the ventilation system is configured to be controlled by the user interface to set, operate and adjust the apertures, and the ventilation system includes at least one of: automatic, semi-automatic, and manually controlled apertures.

45. The outdoor warming device of claim 1 wherein the user interface uses at least one of tactile, membrane, piezoelectric, capacitance, resistance, induction system, touch panel, padless touch soft switch, padless touch digital encoder, infrared frequency dependent, magnetic switches, field effect, charge transfer, Hall Effect, micro encoder, computer keyboard, computer screen, infrared signal, sound, radio frequency and keypad for selection of operations.

46. The outdoor warming device of claim 1, wherein the user interface is configured to be at least one of shown and hidden when the drawer is closed.

47. The electronically controlled warmer of claim 42 wherein the sensor system is configured to determine at least one of a presence of an item and a temperature of an item in the warmer through use of a scanning infrared detection system coupled to the sensor system.

48. The outdoor warming device of claim 1 wherein the drawer is at least one of a wire rack, pan, plate, and other structure that can be removed from the chamber.
